(19) United States
(12) Patent Application Publication
(10) Pub. No.: US 2008/0265860 A1
(43) Pub. Date: Oct. 30, 2008

(54) Low voltage bandgap reference source

(75) Inventors: Dennis A. Dempsey, Newport (IE); Stefan Marinca, Dooradoyle (IE)

Correspondence Address: WOLF GREENFIELD & SACKS, P.C., 600 ATLANTIC AVENUE, BOSTON, MA, 02210-2206, US

(73) Assignee: Analog Devices, Inc., Norwood, MA (US)

(21) Appl. No.: 11/796,964

(22) Filed: Apr. 30, 2007

(51) Int. Cl. G05F 3/20

(52) U.S. Cl. 323/314; 323/313

(57) ABSTRACT

A bandgap voltage reference circuit is described. By providing first and second bipolar devices that are operable with different current densities a base emitter voltage difference is created. This voltage difference is increased by coupling first and second cascode circuits to the first and second bipolars, the cascode circuits also being scaled relative to one another.

### FIELD OF THE INVENTION

The present invention relates to bandgap references and in particular to a bandgap reference that is operational in low voltage supply environments.

### BACKGROUND

Bandgap references are well known to provide stable output voltage or current supplies which are largely independent of external environmental conditions.

Such circuits are typically based on the generation of a difference in base-emitter voltages of bipolar transistors. An example of such as circuit is that described in commonly assigned U.S. Pat. No. 6,853,238, the content of which is incorporated herein by way of reference. Such a circuit is useful in providing either a voltage or a current output and is particularly effective in applications requiring small integrated circuit area and low power.

Despite the advantages of such circuitry there is still a need to provide a circuit that may be implemented in low power supply environments where the level of available supply voltage is lower than traditionally available, circa 5 volts. In such environments it is commonplace for the minimum supply voltage available to be around 1 volt or less. Such environments are becoming more and more common as lower supply operation is a requirement for shrinking wafer fabrication process geometries with lower voltage requirements. In CMOS technology less than 500 nm there is a requirement for less than 5V arising from limitations in device breakdown characteristics. Furthermore, the CMOS supply level process capability continues to reduce less than 1V with shrinking process geometries below 100 nm. With regard to applications it will be understood that lower voltage is also beneficial for lower power operation which is becoming more and more important for reasons including reduced cooling costs and improved reliability, and also in portable electronics environments where there are issues with regard to battery power capability. It will also be understood that in today's environmentally conscious environment that there is a general desire for improved power efficiencies.

### SUMMARY

These and other problems are addressed by a circuit in accordance with the teaching of the invention which is operable in low supply environments. Such a circuit using a combination of first and second circuit elements, which are scaled relative to one another and, which are coupled to cascode circuits which are also scaled relative to one another may be used to generate a PTAT voltage across a resistor that is coupled to an amplifier input.

By using circuit elements formed using bipolar transistors or the like it is possible to effect the formation of a difference in base emitter voltages between the two transistors across the resistor. By using diode devices, the voltage difference formed across the resistor will be a diode voltage difference.

The cascode circuit may typically be implemented using MOS devices which are scaled relative to one another. By arranging the circuit elements and cascode devices in two legs, with the scaled MOS device coupled to the non scaled circuit element and the scaled circuit element coupled to the non-scaled MOS device it is possible to maximize the PTAT voltage generated across the resistor such that a resulting PTAT current is less sensitive to amplifier's voltage offset and noise.

These and other features will be better understood with reference to the following drawings.

### BRIEF DESCRIPTION OF THE DRAWINGS

The present invention will now be described with reference to the accompanying Figures.

FIG. 1 which is an example of a circuit in accordance with the teaching of the invention which provides for generation of an enhanced base emitter voltage.

FIG. 2 is an example of a modification to the circuit of FIG. 1 to which a complimentary to absolute temperature (CTAT) component is coupled into the circuit block of FIG. 1.

FIG. 3 is an example of the type of circuitry that could be used to generate the CTAT component of FIG. 2.

FIG. 4 is an example of how the circuit of FIG. 3 could be modified to generate a voltage reference.

FIG. 5 is an example of how calibration could be introduced into the circuit of FIG. 4.

### DETAILED DESCRIPTION OF THE DRAWINGS

The invention will now be described with reference to exemplary circuits thereof which are provided to assist in an understanding of the teaching of the invention.

As shown in FIG. 1, such a circuit includes a bandgap reference 100 with low supply voltage operation and both voltage and current output capability. The circuit may be considered as having a first and second path or first and second legs, each including first and second MOS devices. In a first path from the node “f” to the common ground there is provided a first cascode transistor, MP2, and a bipolar transistor, QP1. In a second path from the node “f” to the common ground there is a second cascode transistor, MP1, a resistor, R1, and a bipolar transistor, QP2. In a preferred unipolar arrangement such as that shown in FIG. 1, the commonly coupled gate terminals of the first and second cascode transistors (MP2, MP1) are coupled to the ground signal to minimize the power supply voltage requirement. It will be understood however that the gate control of MP1 and MP2 can be coupled to levels other than ground if/as desired. The first and second paths are coupled to first and second inputs of the amplifier A1, the first path desirably to the non-inverting input and the second path to the inverting input of the amplifier. The output of the amplifier is coupled in a feedback configuration to both of the first and second cascode MOS devices such that each of the two devices is driven with the same current.

The commonly coupled gates of the two cascode devices are also coupled to commonly coupled bases of each of the two bipolar transistors. The MOS transistors are configured to control the emitter currents of the two bipolar transistors, QP1 and QP2, where QP2 has an emitter area n1 times larger than that of Q1. Due to the collector current density differences between QP1 and QP2, a base-emitter voltage difference, V_{BE}, which is of the form of a Proportional to Absolute Temperature (PTAT) voltage, is developed across a resistor, R1. If MP2 and MP3 are assumed to be identical and the amplifier A1 has no input offset voltage, then the emitter currents of QP1 and QP2 have the same value.

The circuit of FIG. 1 creates and maximizes the base-emitter voltage difference between the first and second bipolar transistors, the PTAT voltage, which is developed across R1. By increasing this base-emitter voltage difference the resulting PTAT current is less sensitive to amplifier's voltage offset and noise. In the circuit of FIG. 1 the base-emitter voltage difference is increased firstly by providing QP2 with a scaled emitter area to that of QP1. In this arrangement it is scaled “n1” larger than that of QP1, it is a scalar multiple of QP1. The base-emitter voltage is also increased by scaling the first cascode transistor MP2 relative to the second cascode transistor MP1, such that MP2 is a scalar multiple of MP1. This may be achieved in any one of a number of different ways such as for example by using “n2” parallel unit devices of similar construction to MP1. The base-emitter voltage difference developed across R1 is therefore:

$$Δ {V}_{be} = {V}_{R 1} = \frac{KT}{q} ln ( n 1 * n 2 ) \qquad ( 1 )$$

Where:
k is the Boltzmann constant,
q is the charge on the electron,
T is the operating temperature in Kelvin.

Ideally, the drain currents of MP1 and MP2 are:

$$\begin{matrix}{I}_{D} ( MP 1 ) = \frac{Δ {V}_{be}}{R 1} ; & {I}_{D} ( MP 2 ) = n 2 * \frac{Δ {V}_{be}}{R 1}\end{matrix} \qquad ( 2 )$$

By providing such an arrangement it is evident that each of the two legs are scaled differently in that the MOS device on the first leg is scaled relative to the MOS device on the second leg whereas the bipolar device on the second leg is scaled relative to the bipolar device on the first leg. Such a circuit is ideally suited for generation of a PTAT output. By providing a bias pin V_{B} at the amplifier A1, it is possible to regulate or bias the cascode devices to a suitable level. The value of the base emitter voltage generated across R1 is determined by the gain ratio of the first and second cascode devices and the ratio of the first and second bipolar devices. By using a different device as a load component to a resistor, it is possible to generate temperature dependencies into this value.

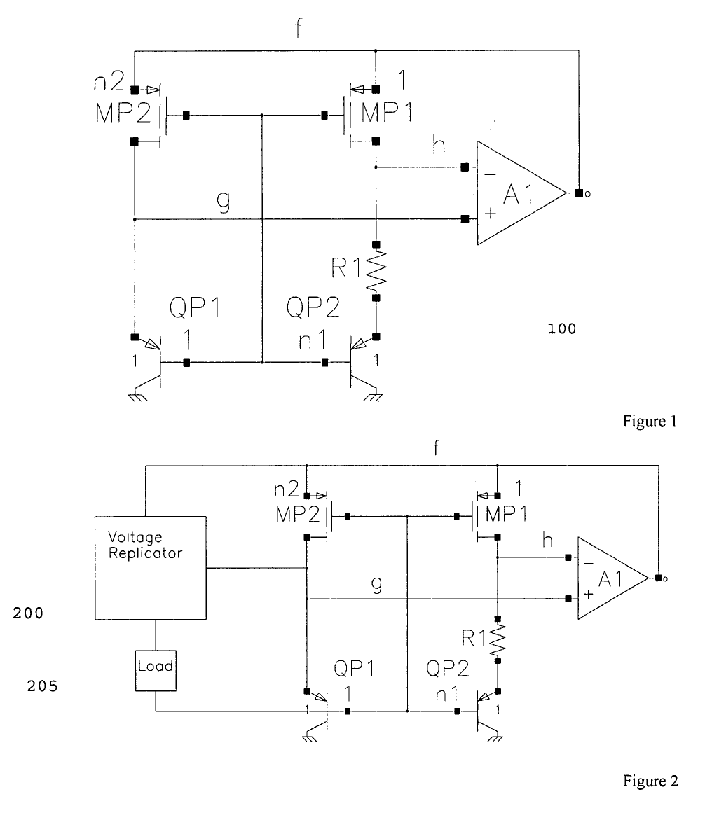

While the generation of a PTAT voltage or current may be desirable for certain applications, FIG. 2 shows a modification to such a circuit where a complimentary to absolute temperature (CTAT) component may be introduced to balance the PTAT component and hence provide a substantially flat output response—suitable for a reference circuit. For the present discussion this response will be considered to a first order, i.e. the contribution of any second order—for example curvature effects—will not be considered. To provide such a CTAT component, a voltage replicator 200 is driven with the same current as each of the two cascode devices, i.e. it is coupled to the node “f”. The replicator is also coupled via a resistive load 205 to the commonly coupled ground of each of the bases of the first and second bipolar devices. The replicator is additionally coupled to the first path between the first bipolar device and the first MOS device, MP1. By providing such an arrangement the replicator and its coupled load device replicate the base-emitter voltage of the first bipolar transistor QP1.

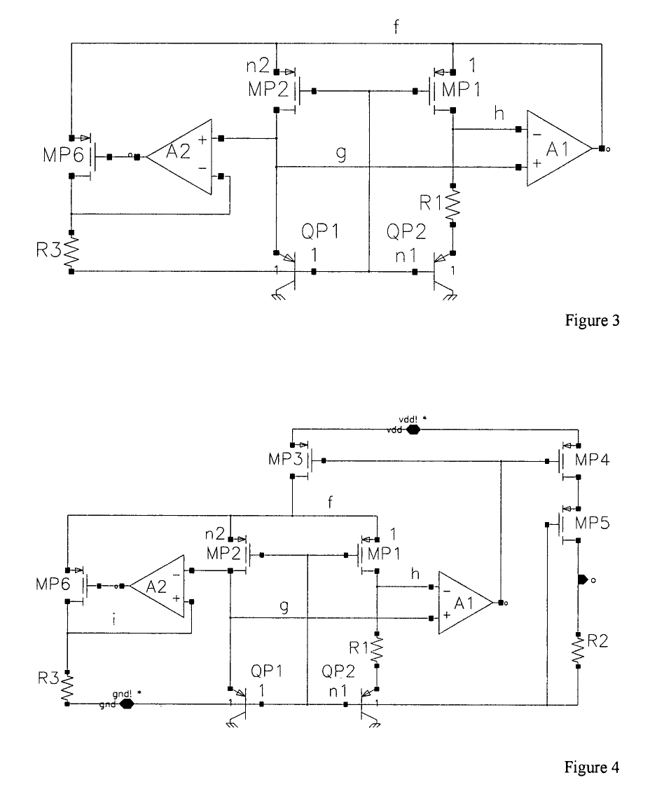

By connecting from the node “f” to the ground a voltage replication circuit, in series with a load device, a current of the form of Complementary To Absolute Temperature (CTAT) will be extracted from node “f”. The voltage replication circuit embodiment shown in FIG. 2 may be implemented as shown in FIG. 3 by use of a MOS transistor MP6, a load resistor R3 and an amplifier A2 to replicate the voltage at input node “g” at output node “i”. Usage of an amplifier stage in combination with a transistor is a preferred usage of the available common mode range. Other voltage replication embodiments are possible, as will be appreciated by those skilled in the art. If the current of resistor R3 is balanced with the sum of the currents passing MP2 and MP1, then the current through MP3 IN FIG. 4 will be a constant current, or Independent To Absolute Temperature (ITAT).

The arrangement of the second amplifier A2 which includes at its output the MOS device MP6 provides a replication the base-emitter voltage of QP1, or node voltage “g” in this embodiment, reflecting it across a second resistor R3, provided between the MOS device MP6 and the ground supply, such that the drain current of MP6 is:

$${I}_{D} ( MP 6 ) = \frac{{V}_{be} ( QP 1 )}{R 3} \qquad ( 3 )$$

The drain current of MP1 is:

$$\begin{matrix}{I}_{D} ( MP 1 ) = {I}_{D} ( MP 2 ) + {I}_{D} ( MP 3 ) + {I}_{D} ( MP 6 ) \\ = ( n 2 + 1 ) * \frac{Δ Vbe}{R 1} + \frac{Vbe ( QP 1 )}{R 3}\end{matrix} \qquad ( 4 )$$

FIG. 4 shows a further modification to the circuits heretofore described where a MOS device MP3 is provided between the node f and the output of the amplifier A1. Such an arrangement is useful in that the characteristics of the MOS device may be used to control the current that is coupled to each of the first and second paths. This may be used independently of, or in conjunction with a bias pin provided on the amplifier to control the first and second paths. In a further modification, the source/drain current of MP3 may be mirrored as the output current for the circuit via fifth and sixth MOS devices, the output devices MP4 and MP5. In the arrangement of FIG. 4, the gates of MP3 and MP4 are commonly coupled to the output of amplifier A1, while the gate of device MP5 is coupled to ground. In normal operation, MP3 and MP4 have the same gate-source voltage and the current via MP4, which is the output current, is also a constant current. The current of MP4 can be used as it is or can be converted in a constant output voltage across a load resistor, R2. An MP5 cascode transistor is included in the circuit of FIG. 4 to increase the current source output impedance in the same fashion as MP2 and MP1, as will be known to those skilled in the art, and thus yield increased power supply rejection. In this arrangement, the output voltage can be scaled by appropriately scaling the values of the resistors R2 and R1.

It will be appreciated by those skilled in the art that the above analysis of the identified currents and voltages neglects contributing factors such as for example dielectric absorption and bipolar transistor output impedances but for the sake of the present understanding is reasonably accurate.

The temperature dependence of the output current is set by the ratio of R1:R3. For a specific value of this ratio the output current is, at a first order, temperature insensitive.

It will be understood that while the device ratios n1 and n2 are often integer values but are not required by the design to be integer values.

The bulk, or body, connections of the MOS devices (all PMOS in this embodiment) are not shown. Conventional CMOS processes are predominantly n-well based processes enabling the PMOS devices' back-gate terminals to be tied, or driven, by a node level other than the relevant supply voltage e.g. designers may choose to tie the back-gate terminals of MP2, MP1 and MP6 to their common back-gate node, node “f”. In such an arrangement there is a reduced device threshold which effects a reduction in the gate-source voltage requirements. The back-gate terminal of MP5 may also be coupled to node “f”.

The circuit according to one or more of the preceding illustrative embodiments is particularly useful for applications requiring small integrated circuit area, low power and low voltage design. Such a circuit is capable of operating at low supply voltage. The minimum supply voltage is set by the sum of the base-emitter voltage of QP1 and the drain-source voltages of MP1/MP2. In this way a circuit is provided which does not have a gate-source voltage circuit limitation on power supply operation and thus circuit according to the teaching of the invention have lower supply capability than previous circuit designs.

It is yet another advantage of the new circuit that the two scalars, n1 and n2, are multiplied by the circuit architecture to yield a large base-emitter voltage difference, usually called PTAT voltage, which is developed in the circuit of FIG. 1 across R1 as described by equation (1) above. The resultant large base-emitter voltage difference increases design manufacturability and performance.

Another advantage of a circuit in accordance with the teaching of the invention is that a single MOS device type, in the illustrated arrangement PMOS devices may be used. PMOS is the typical device on conventional CMOS processes with an independent well, because the back-gate terminal is another design variable which be used to reduce the supply voltage requirement. It will however be understood that equivalent circuits could be implemented using bipolar technologies where one or more bipolar junction transistors (BJTs) could be used as replacement devices for the illustrated MOS devices heretofore described.

In this way, while MP2 and MP1 in FIG. 1 are MOS type devices, it will be appreciated to those skilled in the art that other types and forms of devices and cascode sub-circuits could be used to perform the same function e.g. a bipolar junction transistor could be used. Furthermore, while bipolar junction transistors are shown and used in the circuits of the circuits heretofore described for use in the generation of a base emitter voltage difference, it will be appreciated to those skilled in the art that they function as forward biased diodes and diodes could be used in their place to effect the same function. When used it will be appreciated that a base emitter voltage is not formed, rather a difference in voltage between the two diodes but that this difference is a PTAT voltage and can be used to generate a current or voltage reference source as required.

Lower threshold MOS devices can also be used to reduce the gate-source voltage requirements, as is known to those skilled in the art.

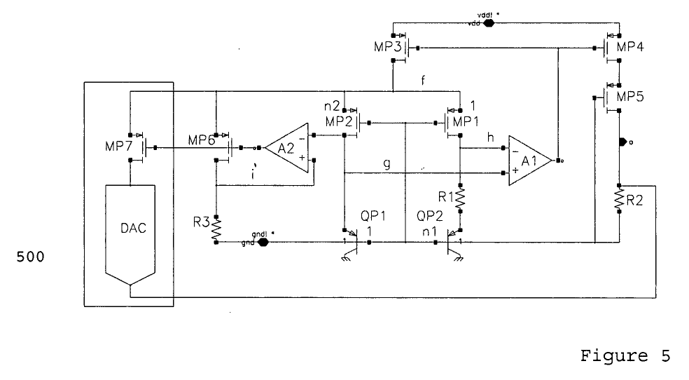

Circuits according to the teaching of the invention may be easily calibrated to address the variances that commonly arise in device performance arising from production variances. Leading sources of variance in bandgap voltage references are the inherent bandgap reference variance, the resistors' sheet rho value variance and resistor mismatch. It will be appreciated by those skilled in the art that DAC functions and RDACs or indeed digital potentiometers can be incorporated into circuits according to the teaching of the present invention to perform calibration, or trimming function in manufacturing, at device power-on, and/or user-driven in the application of such variances in this circuit. FIG. 5 shows an example of such a calibration circuit where a MOS device MP7, coupled to the node ‘f’ and the common gate of MP6 is further coupled to a DAC 500 which is coupled to the node ‘o’. Such an arrangement or modifications thereto can be used to inject or extract a suitable PTAT or CTAT or ITAT current at the node ‘o’ to impose a specific temperature dependence. By using a DAC or similar tuneable component it is possible to define the proportion of temperature dependency that is introduced at or extracted from the output node. In this, or a similar fashion, it is possible to modify the PTAT, CTAT and ITAT currents such that they are predominately or substantially PTAT, CTAT or ITAT as appropriate but may include characteristics of other temperature dependencies. Circuitry useful to provide such modifications will be known to those skilled in the art.

Other techniques that can be used within the context of the teaching of the present invention include a trimming of one or more of the resistors in FIG. 3 or 4. A further modification would be a calibration or changing of the MOS current mirror ratios or indeed the ratios of the cascode circuit device values.

It will be understood that what has been described herein are illustrative circuit schematics provided in accordance with the teaching of the invention to assist in an understanding of the invention. Such exemplary arrangements are not to be construed as limiting the invention in any way, except as may be deemed necessary in the light of the appended claims. Components described with reference to one Figure may be interchanged with those of other circuits without departing from the spirit and scope of the invention.

The words comprises/comprising when used in this specification are to specify the presence of stated features, integers, steps or components but does not preclude the presence or addition of one or more other features, integers, steps, components or groups thereof.

1. A bandgap reference circuit including an amplifier having a first and second bipolar transistor coupled thereto, the first and second bipolar transistors being configured to operate at different current densities such that a difference in base emitter voltages between the first and second transistors may be generated across a resistive load coupled to the second bipolar transistor, the difference in base emitter voltage being a proportional to absolute temperature voltage, and wherein the circuit additionally includes first and second cascode circuits coupled to the first and second bipolar transistors respectively, the first and second cascode circuits being commonly coupled to the output of the amplifier and scaled relative to one another to increase the base emitter voltage difference that is generated across the resistive load.

2. The circuit of claim 1 wherein the first bipolar transistor is an emitter area that is a scaled multiple of the emitter area of the second bipolar transistor.

3. The circuit of claim 1 wherein the first and second cascode circuits include MOS devices.

4. The circuit of claim 3 wherein the first and second cascode circuits are provided by first and second MOS devices respectively, the second MOS device being a scalar multiple of the first MOS device.

5. The circuit of claim 4 wherein the first and second MOS devices are coupled to the output of the amplifier via a third MOS device, the gate of the third MOS device being coupled to the output of the amplifier.

6. The circuit of claim 4 wherein a commonly coupled node of the first bipolar device and second MOS device is coupled to a voltage replicator circuit configured to provide a complimentary to absolute temperature (CTAT) contribution to that node.

7. The circuit of claim 6 wherein the replicator circuit includes a replicator amplifier coupled at its output to the gate of a replicator MOS device, the replicator MOS device being coupled across a resistor to ground.

8. The circuit of claim 7 wherein the replicator MOS device is also coupled to the output of the amplifier and the common node between the first and second MOS devices such that a complimentary to absolute temperature (CTAT) current is extracted from this common node.

9. The circuit of claim 5 wherein the source/drain current of the third MOS device is mirrored as the output current for the circuit.

10. The circuit of claim 9 wherein the mirroring is effected via a mirror MOS device whose gate is commonly coupled to the output of the amplifier.

11. The circuit of claim 10 wherein the third MOS device and mirror MOS device have the same gate-source voltage and the output current provided at the drain node of the mirror MOS device is a constant current.

12. The circuit of claim 11 wherein the drain node of the mirror MOS device is coupled across a resistor to ground, so as to provide a constant voltage as an output for the circuit.

13. The circuit of claim 12 wherein the drain node of the mirror MOS device is coupled via a cascode MOS device to the resistor, the inclusion of the cascode device increasing the current source output impedance thereby increasing the power supply rejection ratio of the circuit.

14. The circuit of claim 13 wherein a scaling of the load resistor coupled to the output node and the resistive load coupled to the second bipolar transistor provides for a scaling of the output voltage.

15. The circuit of claim 1 including a calibration module, activation of the calibration module providing a calibration function configured to compensate for process variations in the manufacture of the circuit.

16. The circuit of claim 15 wherein the calibration module includes a digital to analog converter (DAC).

17. The circuit of claim 16 wherein the DAC is configured to provide a tuneable current at an output node of the circuit, the current including at least one of a proportional to absolute temperature (PTAT) or complimentary to absolute temperature (CTAT) or independent to absolute temperature (ITAT) component.

18. The circuit of claim 16 wherein the DAC is configured to extract a tuneable current from an output node of the circuit, the current including at least one of a proportional to absolute temperature (PTAT) or complimentary to absolute temperature (CTAT) or independent to absolute temperature (ITAT) component.

19. The circuit of claim 15 wherein each of the first, second, third, fourth and cascode MOS devices are provided as PMOS devices.

20. The circuit of claim 1 wherein the first and second cascode circuits are implemented using bipolar junction transistors.

21. A bandgap reference circuit including an amplifier having a first and second bipolar transistor coupled thereto, the first and second bipolar transistors being configured to operate at different current densities such that a difference in base emitter voltages between the first and second transistors may be generated across a resistive load coupled to the second bipolar transistor, the difference in base emitter voltage being a proportional to absolute temperature voltage, and wherein the circuit additionally includes first and second MOS devices coupled to the first and second bipolar transistors respectively, the first and second MOS devices being commonly coupled to the output of the amplifier and scaled relative to one another to increase the base emitter voltage difference that is generated across the resistive load.

22. A reference circuit including an amplifier having a first and second circuit elements coupled thereto, the first and second circuit elements being configured to operate relative to one another such that a voltage difference between the first and second circuit elements may be generated across a resistive load coupled to the second circuit element, the voltage difference being a proportional to absolute temperature voltage, and wherein the circuit additionally includes first and second cascode circuits coupled to the first and second circuit elements respectively, the first and second cascode circuits being commonly coupled to the output of the amplifier and scaled relative to one another to increase the voltage difference that is generated across the resistive load.

23. The circuit of claim 22 wherein the first and second circuit elements are forward biased diodes.

24. The circuit of claim 22 wherein the first and second circuit elements are bipolar transistors and the difference in voltage between the two circuit elements that is generated across the resistive load coupled to the second circuit element is a difference in base emitter voltages between the first and second bipolar transistors.

25. A bandgap voltage reference circuit configured to provide a voltage reference at an output thereof, the circuit including:
a. an amplifier having a first and second bipolar transistor coupled thereto, the first and second bipolar transistors being configured to operate at different current densities such that a difference in base emitter voltages between the first and second transistors may be generated across a resistive load coupled to the second bipolar transistor, the difference in base emitter voltage being a proportional to absolute temperature voltage, and wherein the circuit additionally includes first and second MOS devices coupled to the first and second bipolar transistors respectively, the first and second MOS devices being commonly coupled to the output of the amplifier and scaled relative to one another to increase the base emitter voltage difference that is generated across the resistive load,
b. A voltage replicator circuit coupled to a commonly coupled node of the first bipolar device and second MOS device and configured to provide a complimentary to absolute temperature (CTAT) contribution to that node,
c. A buffer device provided between the first and second MOS devices and the output of the amplifier, the buffer device being configured to control the current provided to the first and second MOS devices,
d. A current mirror coupled to the buffer device and configured to reflect the current across the buffer device to an output of the circuit, the mirrored current being applied through a cascode device at the output and across a resistive load to generate the voltage reference.
